(19) United States
(12) Patent Application Publication
(10) Pub. No.: US 2019/0200169 A1
(43) Pub. Date: Jun. 27, 2019

(54) SYSTEM AND METHOD TO LOCALISE AN ENTITY

(71) Applicant: Clean Slate Technologies Pvt. Ltd., Mumbai (IN)

(72) Inventors: Aman Bapna, Udaipur (IN); Anubhaw Kumar, Patna (IN); Mayank Sharma, Bhopal (IN); Siddharth Desai, Mumbai (IN)

(21) Appl. No.: 16/220,081

(22) Filed: Dec. 14, 2018

(30) Foreign Application Priority Data
Dec. 14, 2017 (IN) 201721045039
Dec. 15, 2017 (IN) 201721045087

(51) Int. Cl. H04W 4/029; H04W 4/33

(52) U.S. Cl. CPC H04W 4/029; H04W 4/33

(57) ABSTRACT

System and method to localise an entity are provided. The system includes one or more sensors communicatively coupled to the entity, configured to sense a plurality of data representative of the location of the entity within the indoor environment, a processing subsystem communicatively coupled to the one or more sensors. The processing subsystem includes a raw data collection module configured to generate raw data representative of a plurality of locations within the indoor environment, wherein the raw data is collected by the one or more sensors and to create a floor map of the indoor environment based on the raw data generated, a computing module configured to compare the plurality of data sensed by the corresponding one or more sensors with the raw data using a computing technique, a location monitoring module configured to compute a location of the entity within the indoor environment based on a compared result.

### CROSS-REFERENCE TO RELATED APPLICATION

This application claims the benefit of Provisional Applications bearing application no. 201721045039 having title “SYSTEM AND METHOD TO LOCALISE AN OBJECT” filed on Dec. 14, 2017 and application no. 201721045087 having titled “SYSTEM AND METHOD FOR OBJECT LOCALISATION” filed on Dec. 15, 2017 in India.

### FIELD OF INVENTION

Embodiments of the present disclosure relate to localisation, and more particularly to a system and method to localise an entity in an indoor environment.

### BACKGROUND

Localisation is a technique of determining a location of an entity whether in a stationary position or while moving. The entity to be localised may be an electronic device, a vehicle, a human being, an object associated with an inventory or the like. Further with the linear growth in technology, many ways are used to localise the entity.

In one approach, an object may be localised using a position tracking system which is inbuilt in the object. Such systems help to locate the object continuously in real time and are also used in a wide variety of applications. However, such type of systems is restricted to certain area. More specifically localising an object in an indoor environment produces lower precision and is challenging.

In another approach, the localisation of an object is done using wireless technologies such as satellite, radio wave, or the like. These systems help in getting an exact or most accurate location of the object. However, such systems are restricted to line-of-sight for location signal. Also, such systems suffer from interference from different environmental causes such as a multi-path fading, interference of radio waves, or the like.

In yet another approach, the localisation of an object is done through interfacing a global system for mobile communication (GSM) module positioning system with a couple of other tracking devices which gives the exact location of an object. However, such systems lack to give an exact location of the object in an indoor environment as the electromagnetic waves may shield the atmosphere making such an approach less accurate and hence lacks to meet the required needs. Also, locating a human in such an approach is a tedious process as the human must be entangled with the GSM and the positioning system whose feasibility is almost impossible.

In yet another approach, the localisation is done by using global positioning system (GPS) and local positioning system separately and combing both the positions to get the desired location of the object. GPS measuring sensors provide the accurate location in the outdoor environment as the global position information is known. However, the global positioning sensors for indoor environment are very expensive and also installation of such sensors is very difficult. Also due to environmental disturbances, such systems may produce a loss or damage in the desired information.

In yet another approach, the localisation of the object is done with the help of plurality of sensors and a raw data. However, in such systems, the plurality of sensors provide various noise which has to be filtered before calculating the location of the object, which makes the system complicated and time consuming. Also, hardware of such systems is surplus which makes such an approach bulky because of which power consumption by such systems becomes high. Further huge consumption of power makes such systems expensive. Such expenses lead to complexity towards implementation of the system. In addition, such approaches are more prone to be influenced by noise, thereby making the system less reliable.

Hence, there is a need for an improved system and method to localise the object to address the aforementioned issues.

### BRIEF DESCRIPTION

In accordance with one embodiment of the disclosure, a system to locate an entity within an indoor environment is provided. The system includes one or more sensors communicatively coupled to the entity. The one or more sensors includes one of a plurality of inertial sensors and one or more radio frequency sensors. The one or more sensors is configured to sense data representative of a plurality of locations within the indoor environment. The plurality of sensors is also configured to sense a plurality of data representative of a location of the entity within the indoor environment. The system also includes a processing subsystem communicatively coupled to the one or more sensors. The processing subsystem includes a raw data collection module. The raw data collection module is configured to generate raw data representative of a plurality of locations within the indoor environment based on the data sensed by the one or more sensors. The raw data collection module is also configured to create a floor map of the indoor environment based on the raw data generated. The processing subsystem also includes a computing module communicatively coupled to the raw data collection module. The computing module is configured to compare the plurality of data representative of the location of the entity within the indoor environment sensed by the corresponding one or more sensors with the raw data using a computing technique. The processing subsystem also includes a location monitoring module communicatively coupled to the computing module. The location monitoring module is configured to compute a location of the entity within the indoor environment based on a compared result in real time.

In accordance with another embodiment of the disclosure, a method for locating an entity within an indoor environment is provided. The method includes generating raw data representative of a plurality of locations within the indoor environment. The method also includes creating a floor map of the indoor environment based on the raw data generated. The method also includes sensing a plurality of data representative of the location of the entity within the indoor environment by one or more sensors, wherein sensing the plurality of data representative of the location of the entity within the indoor environment by one or more sensors comprises sensing the plurality of data representative of the location of the entity within the indoor environment by one of a plurality of inertial sensors and one or more radio frequency sensors. The method also includes comparing the plurality of data sensed by the corresponding one or more sensors with the raw data using a computing technique. The method also includes computing a location of the entity within the indoor environment based on a compared result computing, by a location monitoring module, a location of the entity within the indoor environment based on a compared result.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a block diagram representation of a system to locate an entity within an indoor environment in accordance with an embodiment of the present disclosure;

FIG. 2 is a block diagram representation of an exemplary embodiment of a system to locate a wheeled assembly of FIG. 1 in accordance with an embodiment of the present disclosure;

FIG. 3 is a block diagram representation of a processing subsystem located on a local server or on a remote server in accordance with an embodiment of the present disclosure; and

FIG. 4 is a flow chart representing steps involved in a method for locating an entity within an indoor environment in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present disclosure relate to system and method to localise an entity are provided. The system includes one or more sensors communicatively coupled to the entity. The one or more sensors includes one of a plurality of inertial sensors and one or more radio frequency sensors. The one or more sensors is configured to sense data representative of a plurality of locations within the indoor environment. The plurality of sensors is also configured to sense a plurality of data representative of a location of the entity within the indoor environment. The system also includes a processing subsystem communicatively coupled to the one or more sensors. The processing subsystem includes a raw data collection module. The raw data collection module is configured to generate raw data representative of a plurality of locations within the indoor environment based on the data sensed by the one or more sensors. The raw data collection module is also configured to create a floor map of the indoor environment based on the raw data generated. The processing subsystem also includes a computing module communicatively coupled to the raw data collection module. The computing module is configured to compare the plurality of data representative of the location of the entity within the indoor environment sensed by the corresponding one or more sensors with the raw data using a computing technique. The processing subsystem also includes a location monitoring module communicatively coupled to the computing module. The location monitoring module is configured to compute a location of the entity within the indoor environment based on a compared result in real time.

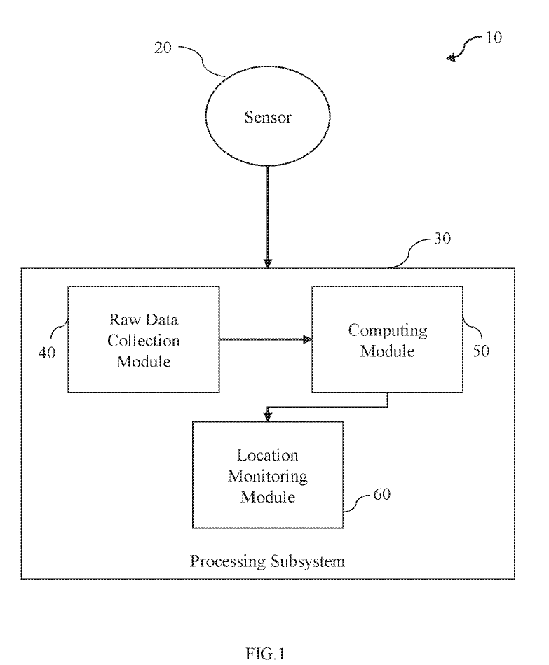

FIG. 1 is a block diagram representation of a system (10) to locate an entity within an indoor environment in accordance with an embodiment of the present disclosure. The system (10) includes one or more sensors (20) communicatively coupled to the entity. In one embodiment, the entity may include one of an object, a wheeled assembly, an autonomous vehicle and a human being. In such embodiment, the wheeled assembly may be a forklift, a manual cart, a motorised cart, a tow-tugger, a tow-truck or a fork truck which may be used in managing the logistics or a cargo delivery.

Further, the one or more sensors (20) includes one of a plurality of inertial sensors and one or more radio frequency sensors. The one or more sensors (20) is configured to sense data representative of a plurality of locations within the indoor environment. The one or more sensors (20) is also configured to sense a plurality of data representative of a location of the entity within the indoor environment.

In one embodiment, the plurality of inertial sensors may include at least one of an accelerometer sensor, a gyroscopic sensor and a magnetometer sensor. As used herein, the term “accelerometer” is defined as an electronic device used to measure acceleration of the entity. Also, the term “magnetometer” is defined as an instrument to measure magnetism either the magnetisation of a magnetic material or a direction, strength or a relative change of a magnetic field at a particular location of the entity. Further, the term “gyroscope” is defined as a device used for measuring or maintaining an orientation and an angular velocity of the entity when the entity is in motion.

In another embodiment, the one or more radio frequency sensors may include at least one of a radio frequency identifier (RFID), a wireless fidelity (Wi-Fi) module, a Bluetooth module and a Bluetooth low energy (BLE) module.

As used herein, the term “WI-FI” is defined as a technology used for wireless local area networking with devices based on a certain standard. Further, the term “Bluetooth” is defined as a standard technology for a shorth range for wireless interconnection of a computer device. Also, the term “BLE” is defined as a wireless personal area network technology which is intended to provide considerable reduce in power consumption. In such embodiments, a BLE trilateration may be used to locate an accurate position of the entity.

In such embodiment, the one or more sensors (10) may sense a unique identifier or a signal strength which may be compared with the obtained raw data stored in a database using a plurality of statistics such as a difference in signal strength, a plurality of common Wi-Fi's or a plurality of Beacons detected within different ranges of strength, a pearson Correlation, a spearman Correlation, a difference in distance of nearest AP or the like. Further, a probability equation may be applied on the sensed data obtained by the one or more sensors (20) which may be developed by training a machine learning model.

In such embodiment the probability equation may be developed using a plurality of techniques such as a regression, a random forest, a k-means classification, a support vector machines or the like. In such another embodiment, the probability equation may be developed based on a plurality of parameters such as a plurality of locations, a plurality of devices, a plurality of travelling speed, a plurality of environmental factors or the like. Further, the machine learning model may provide a probability map associated with the floor map of the indoor environment at one or more points on the floor map. Further a centralized processor may select one or more top percentile of the probability map and may assume the top percentile map to be the location of the entity. Further, the centralized processor may perform a clustering analysis on the data received by the corresponding one or more sensors (20) to see if there is a plurality of clusters of a probable location hypothesis in which a plurality of weighted coordinates may be calculated with an assumption that the location of the entity within the indoor environment may diverge to correct point in subsequent predictions. Further, if there are multiple hypothesis with comparable probabilities the final location of the entity may be selected as a weighted average of the multiple hypothesis.

In one embodiment, the one or more sensors (10) may include one or more position sensors which may be configured to locate a position of the entity within the indoor environment, wherein the one or more position sensors may include at least one of a linear position sensor, an angular position sensor and a multi-axis position sensor.

Furthermore, the system (10) also includes a processing subsystem (30) communicatively coupled to the one or more sensors (20). The processing subsystem (30) includes a raw data collection module (40). The raw data collection module (40) is configured to generate raw data representative of a plurality of locations within the indoor environment, wherein the raw data is collected by the one or more sensors (20). As used herein, the term “raw data” is defined as a set of primary data collected from a source. In one exemplary embodiment, the raw data may be collected by one or more users at every possible point location within the indoor environment upon using the one or more sensors (20). In one exemplary embodiment, the processing subsystem (30) may be communicatively coupled to the one or more sensors (20) through a wireless communication medium.

The raw data collection module (40) is also configured to create a floor map of the indoor environment based on the raw data generated. In one embodiment, the floor map may be created by the one or more users based on a plurality of parameters associated with the entity upon using the one or more sensors (20). In such embodiment, the plurality of parameters may include a plurality of locations, a plurality of devices, a travelling speed, a plurality of environmental factors and the like. In such another embodiment, the plurality of parameters may include derived statistics such as time across a moving window, a variance, a standard deviation or a peak to peak ration associated with the entity. The derived statistics may be calculated using the accelerometer sensor which may be used to generate the raw data of the indoor environment to localize the entity. As used herein, the term “moving window” is a type of calculation used to analyse data points by creating a series of averages of different subsets of a full data set. Also, the term “variance” is defined as an expectation of a squared deviation for a random variable from a mean in probability theory and statistics. Further, the term “standard deviation” is defined as a measure that is used to quantify the amount of variation or dispersion of a set of data values.

In one exemplary embodiment, the system (10) may further include a memory (not shown in FIG. 1) operatively coupled to the processing subsystem (30). The memory may be configured to store the raw data representative of a plurality of locations within the indoor environment. In such embodiment, the memory may be at least one of a local storage memory and a remote storage memory.

The processing subsystem (30) also includes a computing module (50) communicatively coupled to the raw data collection module (40). The computing module (50) is configured to compare the plurality of data representative of the location of the entity within the indoor environment sensed by the corresponding one or more sensors (20) with the raw data using a computing technique. In one embodiment, the computing technique may be one of a machine learning technique and an artificial intelligence technique. As used herein, the term “artificial intelligence” sometimes referred as machine intelligence, is defined as an intelligence demonstrated by machines, in contrast to natural intelligence displayed by humans and other animals, such as visual perception, speech recognition, decision-making, and translation between languages. Also, the term “machine learning” which is an application of artificial intelligence (AI) is defined as an ability to automatically learn and improve from experience without being explicitly programmed by humans.

In one exemplary embodiment, the computing module (50) may be configured to detect whether the entity is at rest or in motion upon receiving the plurality of data from the corresponding one or more sensors (20). In such embodiment, depending on the motion of the entity, the computing module (50) may select an appropriate machine learning model to accurately detect the location of the entity within the indoor environment. In one embodiment, the machine learning model may be derived from a plurality of trained models which may be trained in the plurality of locations where the localisation of the entity may take place within the indoor environment.

In one exemplary embodiment, the computing module (50) may also be configured to detect the distance travelled by the entity within the indoor environment. In such embodiment, the one or more sensors (20) may be coupled to a computing device of the entity being the human. In one embodiment, the computing device may be a portable device or a hand-held device. The hand-held device may include one of a mobile phone, a tablet and a laptop. In such another embodiment, the one or more sensors (20) may be coupled to the entity through a hardware platform. Further, the distance travelled by the entity within the indoor environment may be calculated upon comparing the plurality of data representative of the location of the entity sensed by the corresponding one or more sensors with one of the raw data and the floor plan from a start location.

Furthermore, the processing subsystem (30) includes a location monitoring module (60) communicatively coupled to the computing module (50). The location monitoring module (60) is configured to compute a location of the entity within the indoor environment based on a compared result in real time.

In one specific embodiment, the system (10) may further include a navigation module (not shown in FIG. 1) communicatively coupled to the location monitoring module (60). The navigation module may be configured to detect navigation of the entity within the indoor environment in real time. In such embodiment, the navigation module may include at least one of a global positioning system (GPS) module, radio frequency identification (RFID) or a global system for mobile communication (GSM). In one exemplary embodiment, the navigation module may be further configured to detect the navigation of the entity from an outdoor environment into the indoor environment thereby tracking the location of the entity in real time. Further, upon transition of the entity from the outdoor environment to the indoor environment, the one or more sensors may sense an accurate location and may initiate to navigate the location of the entity within the indoor environment. In such embodiment, an outdoor navigation system may be used to detect the location of the entity in the outdoor environment. Further, such data may be transmitted to the system (10) in order to enable tracking and localising the entity within the indoor environment.

Furthermore, in one exemplary embodiment, the location monitoring module (60) and the navigation module may be communicatively coupled to the centralised processor through the wireless communicating medium through internet. Further, the monitored location and the navigation of the entity may be updated to the centralised processor in real time.

In one exemplary embodiment, the accelerometer sensor of the plurality of inertial sensors may be used to determine distance travelled by the entity within the indoor environment. In case of the entity being a human, the distance travelled may be calculated based on a plurality of steps taken by the human within the indoor environment. In another case where the entity being the wheeled assembly or the object, the distance travelled may be calculated based on number of rotation of at least one wheel within the indoor environment, wherein the number of rotations of the at least one wheel is associated with the wheeled assembly or the object. In such embodiment, every time a step is taken by the human, normal force exerted by ground results in a sudden jump in the accelerometer sensor reading, each step is profiled as a crest and a trough observed in the raw data associated with the accelerometer sensor data.

In addition, the distance travelled by the entity may be calculated upon coupling a low pass filter to the processing subsystem (30) and observing the moving window variance, the standard deviation, the peak to peak ration and the average acceleration values associated with the entity. Furthermore, based on a result of the distance travelled, a cutoff value for classifying a crest-trough pattern as an actual step or a false positive step of the entity being the human may be determined. Further, the number of steps taken by the human multiplied by a stride length of each step may be used to compute and estimate the distance travelled by the human.

In another exemplary embodiment, the magnetometer sensor and the gyroscopic sensor of the plurality of inertial sensors may be used to determine a direction of motion of the entity within the indoor environment with comparison to earth's magnetic flux. In such embodiment, the magnetometer sensor may be used to calculate at least one of magnetic field density and pattern of the magnetic field at every point location point within the indoor environment which may be used as the raw data. Further, upon sensing at least one of a current magnetic field density and current pattern of the magnetic field associated with the location of the entity within the indoor environment in real time, the current magnetic field density may be compared with the corresponding magnetic field density and the pattern of the magnetic field of the raw data in order to accurately locate or monitor the location of the entity within the indoor environment.

In one exemplary embodiment, if the entity is associated with a metallic component, a correction technique may be applied on an obtained location of the entity in order to reduce disturbance caused by the metallic component on the magnetic field density and pattern of the magnetic field. In addition, the correction technique may also be applied on the raw data to remove biasing which may be introduced by the entity associated with the metallic component.

In addition, upon detecting the distance travelled and the orientation of the new position of the entity being the wheeled assembly is updated, a particle filter technology may be used to predict a final location of the entity within the indoor environment. Also, the particle filter technology may maintain a plurality of positions which may be updated to the database regularly or when a new data comes in. As used herein, the term “particle filter” also known as Sequential Monte Carlo (SMC) is defined as a technique used to solve filtering problem arising in signal processing. In such embodiment, a plurality of errors which may arise upon computing the location of the entity may be eliminated. In another embodiment, if the entity is found to be stationary, the plurality of data which may be required to calculate the acceleration or deceleration of the entity may be rejected upon incorporating the particle filter technology to localise the entity.

In yet another exemplary embodiment, a plurality of radio signals may be calculated using the one or more radio frequency sensors at each location point within the indoor environment and may be stored as the raw data which may be further utilised to create the floor map. In such embodiment, a current intensity of the radio signal associated with the location of the entity within the indoor environment may be calculated using the one or more radio frequency sensors. Further, the current intensity of the radio signal may be compared and matched with the raw data comprising the plurality of radio signals in order to compute the accurate location of the entity within the indoor environment.

In one specific embodiment, the processing subsystem (30) may further include an alert module (not shown in FIG. 1) which may be communicatively coupled to the centralised processor. The alert module may be configured to generate an alert upon detecting a deviation or variation in the location or the navigation of the entity with the indoor environment. In such embodiment, the start location and the destination location may be predefined for the entity. Also, an optimised path may be generated by the processing subsystem (30) for the entity to reach the destination location from the start location within the indoor environment. In one embodiment, the alert may be one of a text notification, a voice notification, a multimedia notification and the like.

In one exemplary embodiment, the system (10) may further include a display interface (not shown in FIG. 1) which may be operatively coupled to the processing subsystem (30). In such embodiment, the location and the navigation of the entity within the indoor environment may be displayed on the display interface in real time. In one specific embodiment, the display interface may be coupled to the wheeled assembly or the object. In another specific embodiment, the display interface may be coupled to the hand-held device of the human.

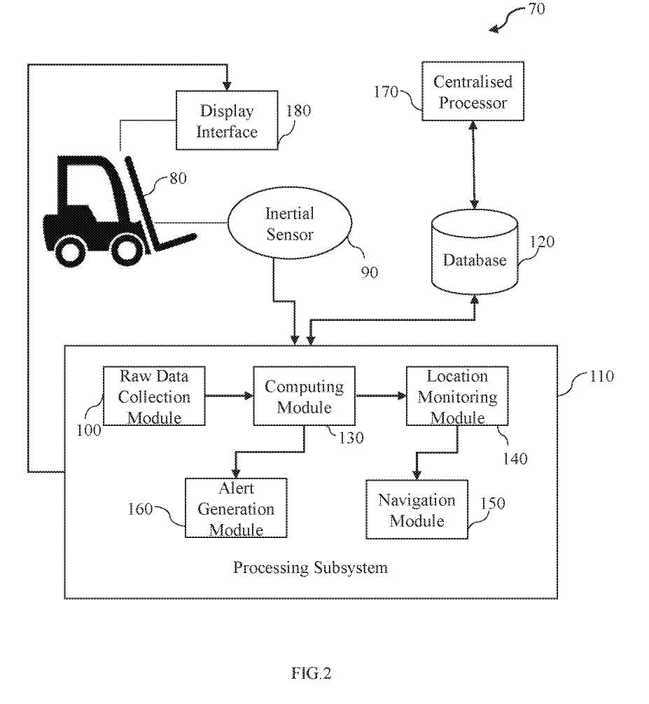

FIG. 2 is a block diagram representation of an exemplary embodiment of a system (70) to locate a wheeled assembly (80) of FIG. 1 in accordance with an embodiment of the present disclosure. The wheeled assembly (80) is used to manage logistics in an indoor environment. The wheeled assembly (80) is coupled with a plurality of inertial sensors (90) comprising an accelerometer sensor, a magnetometer sensor and a gyroscopic sensor. The plurality of inertial sensors (90) senses a plurality of data representative of the location of the wheeled assembly (80) within the indoor environment. Prior to enable the plurality of inertial sensors (90) to sense the data representative of the location of the wheeled assembly (80), the plurality of inertial sensors (90) is used to generate raw data and create a floor map of the indoor environment upon using the raw data by a raw data collection module (100) which is located within a processing subsystem (100). Further, the raw data is stored in a database (120) as a reference data.

Consequently, as the plurality of inertial sensors (90) senses the plurality of data, the plurality of data is compared with the raw data by a computing module (130) using a computing technique. As a result of comparison, the computing module (130) generates a comparison result. Furthermore, based on the comparison result, a location monitoring module (140) computes an exact location of the wheeled assembly (80) within the indoor environment. In addition, a start location and a destination location of the wheeled assembly (80) may be pre-defined. Further, based on the start location and the destination location, the processing subsystem (110) generates an optimised path for the wheeled assembly (80) to reach the destination location from the start location.

Subsequently, based on the accurate location of the wheeled assembly (80), a navigation module (150) monitors navigation of the wheeled assembly (80) from the start location to the destination location based on the optimised path generated by the processing subsystem (110).

Furthermore, in a situation, where the wheeled assembly (80) misses out to follow the optimised path generated by the processing subsystem (110), an alert generation module (160) generates a voice alert through one or more speakers located on the wheeled assembly (80) in order to bring back the wheeled assembly (80) to follow the optimised path, also the same is updated to the centralised processor (70) by the processing subsystem (110).

Also, the processing subsystem (110) displays the optimised path generated by the processing subsystem (110) on a display interface (180) coupled to the wheeled assembly (80). In addition, the alert generation module (160) also enables the processing subsystem (110) to display the generated alert.

Furthermore, the plurality of inertial sensors (90), the processing subsystem (110), the raw data collection module (100), the computing module (130) and the location monitoring module (140) are substantially similar to one or more sensors (20), a processing subsystem (30), a raw data collection module (40), a computing module (50) and a location monitoring module (60) of FIG. 1.

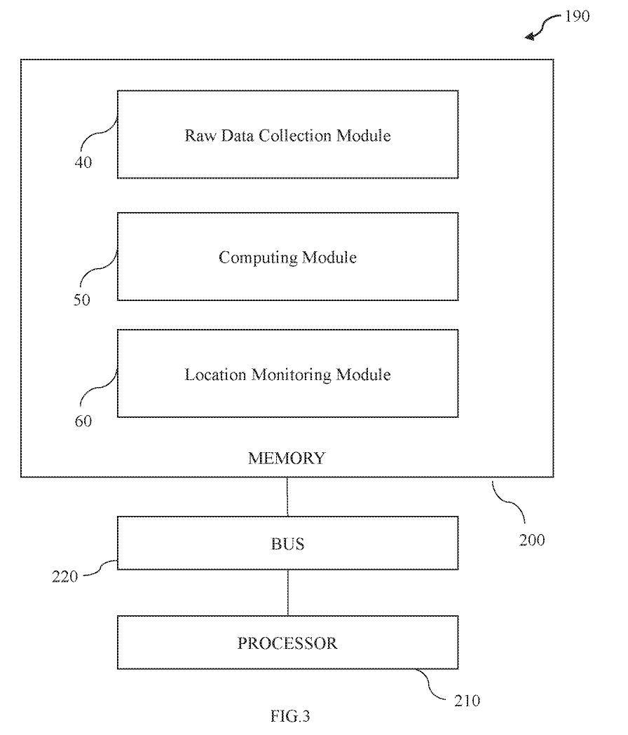

FIG. 3 is a block diagram representation of a processing subsystem located on a local server or on a remote server in accordance with an embodiment of the present disclosure. The computer system (190) includes processor(s) (200), and memory (210) coupled to the processor(s) (200) via a bus (220).

The processor(s) (210), as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a digital signal processor, or any other type of processing circuit, or a combination thereof.

The memory (200) includes a plurality of modules stored in the form of executable program which instructs the processor (210) to perform the configuration of the system illustrated in FIG. 1. The memory (200) has following modules: a raw data collection module (40) configured to generate raw data representative of a plurality of locations within the indoor environment, wherein the raw data is collected by the one or more sensors and to create a floor map of the indoor environment based on the raw data generated, a computing module (50) configured to compare the plurality of data sensed by the corresponding one or more sensors with the raw data using a computing technique and a location monitoring module (60) configured to compute a location of the entity within the indoor environment based on a compared result, wherein the raw data collection module (40), the computing module (50) and the location monitoring module (60) are substantially similar to a raw data collection module (40), a computing module (50) and a location monitoring module (60) of FIG. 1.

Computer memory elements may include any suitable memory device(s) for storing data and executable program, such as read only memory, random access memory, erasable programmable read only memory, electrically erasable programmable read only memory, hard drive, removable media drive for handling memory cards and the like. Embodiments of the present subject matter may be implemented in conjunction with program modules, including functions, procedures, data structures, and application programs, for performing tasks, or defining abstract data types or low-level hardware contexts. Executable program stored on any of the above-mentioned storage media may be executable by the processor(s) (210).

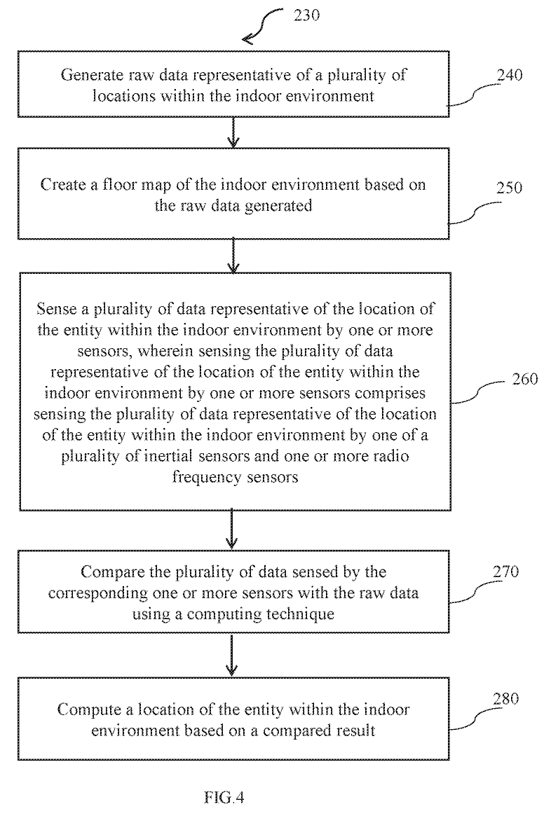

FIG. 4 is a flow chart representing steps involved in a method (230) for locating an entity within an indoor environment in accordance with an embodiment of the present disclosure. The method (230) includes generating raw data representative of a plurality of locations within the indoor environment in step 240. In one embodiment, generating the raw data may include generating the raw data by a raw data generation module. In one exemplary embodiment, generating the raw data may include. In one embodiment, generating the raw data may include generating the raw data representative of a plurality of locations within the indoor environment, wherein the raw data may be generated based on one or more sensed parameters sensed by corresponding one or more sensors. In such embodiment, generating the raw data may include generating the raw data by one or more users at every possible point location within the indoor environment upon using the one or more sensors.

Furthermore, the method (230) includes creating a floor map of the indoor environment based on the raw data generated in step 250. In one embodiment, creating the floor map may include creating the floor map by the raw data collection module. In one exemplary embodiment, creating the floor map may include creating the floor map by the one or more users based on a plurality of parameters associated with the entity upon using the one or more sensors. In such embodiment, the plurality of parameters may include a plurality of locations, a plurality of devices, a travelling speed, a plurality of environmental factors and the like. In such another embodiment, the plurality of parameters may include derived statistics such as time across a moving window, a variance, a standard deviation or a peak to peak ration associated with the entity. The derived statistics may be calculated using the accelerometer sensor which may be used to generate the raw data of the indoor environment to localize the entity.

In one exemplary embodiment, the method (230) may further include storing the raw data representative of a plurality of locations within the indoor environment. In such embodiment, storing the raw data may include storing the raw data by a memory, wherein the memory may include one of a local storage memory and a cloud storage memory.

The method (230) also includes sensing a plurality of data representative of the location of the entity within the indoor environment by the one or more sensors, wherein sensing the plurality of data representative of the location of the entity within the indoor environment by the one or more sensors comprises sensing the plurality of data representative of the location of the entity within the indoor environment by one of a plurality of inertial sensors and one or more radio frequency sensors in step 260. In one embodiment, sensing the plurality of data representative of the location of the entity within the indoor environment by the one or more sensors may include sensing the plurality of data representative of the location of at least one of an object, a wheeled assembly, an autonomous vehicle and a human being. In such embodiment, the wheeled assembly may be a forklift, a manual cart, a motorised cart, a tow-tugger, a tow-truck or a fork truck which may be used in managing the logistics or a cargo delivery.

In one exemplary embodiment, sensing the plurality of data representative of the location of the entity within the indoor environment by the one or more sensors may include sensing the plurality of data representative of the location of the entity within the indoor environment by one of a plurality of inertial sensors and one or more radio frequency sensors. In one embodiment, the plurality of inertial sensors may include at least one of an accelerometer sensor, a gyroscopic sensor and a magnetometer sensor. In another embodiment, the one or more radio frequency sensors may include at least one of a radio frequency identifier (RFID), a wireless fidelity (Wi-Fi) module, a Bluetooth module and a Bluetooth low energy (BLE) module.

The method (230) also includes comparing the plurality of data sensed by the corresponding one or more sensors with the raw data using a computing technique in step 270. In one embodiment, comparing the plurality of data may include comparing the plurality of data by a computing module. In one exemplary embodiment, comparing the plurality of data with the raw data using the computing technique may include comparing the plurality of data with the raw data using a machine learning technique and an artificial intelligence technique. In one exemplary embodiment, the method (230) may further include detecting whether the entity is at rest or in motion upon receiving the plurality of data from the corresponding plurality of sensors. In such embodiment, the method (230) may further include selecting an appropriate machine learning model to accurately detect the location of the entity within the indoor environment. In such another embodiment, the method (230) may further include detecting the distance travelled by the entity within the indoor environment. In one embodiment, detecting the distance travelled by the entity may include detecting the distance travelled by the entity upon comparing the plurality of data representative of the location of the entity sensed by the corresponding one or more sensors with one of the raw data and the floor plan from a start location.

In another exemplary embodiment, the method (230) may further include computing a location of the entity within the indoor environment based on a compared result by a location monitoring module. In yet another exemplary embodiment, the method (230) may further include detecting navigation of the entity within the indoor environment in real time. In such embodiment, the method (230) may further include updating the monitored location and the navigation of the entity to a centralised processor in real time.

In one specific embodiment, the method (230) may also include determining a distance travelled by the entity within the indoor environment. In such embodiment, the method (230) may also include calculating the distance of the entity.

Furthermore, the method (230) also includes computing the location of the entity within the indoor environment based on a compared result in step 280. In one embodiment, computing the location of the entity may include computing the location of the entity by a location monitoring device. In such embodiment, the method (230) may further include generating an alert upon detecting a deviation or variation in the location or the navigation of the entity with the indoor environment. In such embodiment, the method (230) may also include generating an optimised path for the entity to reach the destination location from the start location within the indoor environment. The method (230) may further include displaying the location and the navigation of the entity within the indoor environment on the display interface in real time.

Various embodiments of the present disclosure enable the system to localise the entity within the indoor environment. Usage of the one or more sensors protect the system from intervention of different environmental causes such as a multi-path fading, interference of radio waves, or the like, henceforth making the system more accurate and more reliable.

Also, due to the limited components used in the system, the hardware used in the system is very minimal, henceforth the power consumption by the system is also very minimum, thereby making the system cost effective.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, order of processes described herein may be changed and are not limited to the manner described herein. Moreover, the actions of any flow diagram need not be implemented in the order shown; nor do all of the acts need to be necessarily performed. Also, those acts that are not dependant on other acts may be performed in parallel with the other acts. The scope of embodiments is by no means limited by these specific examples.

We claim:

1. A system to locate an entity within an indoor environment comprising:
one or more sensors communicatively coupled to the entity, wherein the one or more sensors comprises one of a plurality of inertial sensors and one or more radio frequency sensors, wherein the one or more sensors is configured to:
sense data representative of a plurality of locations within the indoor environment;
sense a plurality of data representative of a location of the entity within the indoor environment;
a processing subsystem communicatively coupled to the one or more sensors, wherein the processing subsystem comprises:
a raw data collection module configured to:
generate raw data representative of a plurality of locations within the indoor environment based on the data sensed by the one or more sensors;
create a floor map of the indoor environment based on the raw data generated;
a computing module communicatively coupled to the raw data collection module, and configured to compare the plurality of data representative of the location of the entity within the indoor environment sensed by the corresponding one or more sensors with the raw data using a computing technique; and
a location monitoring module communicatively coupled to the computing module, and configured to compute the location of the entity within the indoor environment based on a compared result in real time.

2. The system as claimed in claim 1, wherein the entity comprises at least one of an object, a wheeled assembly, an autonomous vehicle and a human being.

3. The system as claimed in claim 1, wherein the plurality of inertial sensors comprises at least one of an accelerometer sensor, a gyroscopic sensor and a magnetometer sensor.

4. The system as claimed in claim 1, wherein the one or more radio frequency sensors comprises at least one of a radio frequency identifier (RFID), a wireless fidelity (Wi-Fi) module, a Bluetooth module and a Bluetooth low energy (BLE) module.

5. The system as claimed in claim 1, further comprising a memory operatively coupled to the processing subsystem, and configured to store the raw data representative of a plurality of locations within the indoor environment, wherein the memory comprises at least one of a local storage memory and a remote storage memory.

6. A method for locating an entity within an indoor environment comprising:
generating, by a raw data collection module, raw data representative of a plurality of locations within the indoor environment;
creating, by the raw data collection module, a floor map of the indoor environment based on the raw data generated,
sensing a plurality of data representative of the location of the entity within the indoor environment by one or more sensors, wherein sensing the plurality of data representative of the location of the entity within the indoor environment by one or more sensors comprises sensing the plurality of data representative of the location of the entity within the indoor environment by one of a plurality of inertial sensors and one or more radio frequency sensors;
comparing, by a computing module, the plurality of data sensed by the corresponding one or more sensors with the raw data using a computing technique; and
computing, by a location monitoring module, a location of the entity within the indoor environment based on a compared result.

7. The method as claimed in claim 6, wherein sensing the plurality of data representative of the location of the entity within the indoor environment by the one or more sensors comprises sensing the plurality of data representative of the location of at least one of an object, a wheeled assembly, an autonomous vehicle and a human being.

8. The method as claimed in claim 6, further comprising storing, by a memory, the raw data representative of a plurality of locations within the indoor environment.
